(19) United States
(12) Patent Application Publication
(10) Pub. No.: US 2009/0120760 A1
(43) Pub. Date: May 14, 2009

(54) DUAL USE COIN DEPOSIT AND DISPENSING APPARATUS

(76) Inventor: Anders Sjostrom, Lund (SE)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 12/269,476

(22) Filed: Nov. 12, 2008

Related U.S. Application Data
(60) Provisional application No. 60/987,283, filed on Nov. 12, 2007.

(51) Int. Cl. G07D 5/00

(52) U.S. Cl. 194/302

(57) ABSTRACT

A coin deposit and dispensing apparatus is disclosed. The apparatus is for use in a retail or bank environment by customers and cashiers. The apparatus is configured to receive coins, from either a customer or cashier, and dispense a specific composition of coins to a till for use by a cashier in a retail establishment or bank establishment. The apparatus of the present disclosure is capable for use as a cash deposit apparatus that receives cash (e.g., coins) from customers and provides customers a voucher, receipt, or credit corresponding to the value of the deposited coins.

### CROSS-REFERENCE TO RELATED APPLICATIONS

This application claims the benefit of U.S. Provisional Patent Application No. 60/987,283, filed on Nov. 12, 2008.

### INCORPORATION BY REFERENCE

The entire disclosure of U.S. Provisional Patent Application No. 60/987,283, filed on Nov. 12, 2008 is incorporated herein in their entirety by this reference.

### BACKGROUND OF THE DISCLOSURE

The present disclosure generally relates to cash handling, and more specifically to a coin deposit and dispensing apparatus.

### SUMMARY OF THE DISCLOSURE

In one aspect, the disclosure is generally related to a method of recycling coins. The method comprises providing a coin deposit and dispensing apparatus. The coin deposit and dispensing apparatus comprises a user interface that is accessible to both customers and cashiers, and a cash processor for sorting, counting, validating, and dispensing coins. The method comprises depositing a first amount of coins from a customer accessing the user interface of the coin deposit and dispensing apparatus. The depositing the first amount of coins from the customer comprises operating the cash processor to sort, count, and validate the first amount of coins. The method comprises depositing a second amount of coins from a cashier accessing the user interface of the coin deposit and dispensing apparatus. The depositing the second amount of coins from the cashier comprises operating the cash processor to sort, count, and validate the second amount of coins. The method comprises dispensing a third amount of coins from the cash processor to a cashier. The third amount of coins comprising at least one coin from the first amount of coins and at least one coin from the second amount of coins.

Those skilled in the art will appreciate the above stated advantages and other advantages and benefits of various additional embodiments reading the following detailed description of the embodiments with reference to the below-listed drawing figures.

### BRIEF DESCRIPTION OF THE DRAWINGS

According to common practice, the drawings discussed below are not necessarily drawn to scale. Dimensions of various features and elements in the drawings may be expanded or reduced to more clearly illustrate the embodiments of the disclosure.

FIG. 1 is a perspective front view of a coin deposit and dispensing apparatus according to one embodiment of the disclosure

FIG. 2 is a schematic plan view of a coin deposit and dispensing apparatus according to a second embodiment of the disclosure.

FIGS. 3 and 4 are various schematics of the apparatus of various embodiments of the disclosure.

FIG. 5 is a flow chart of operation of the coin deposit and dispensing apparatus according to various embodiments of the disclosure.

Corresponding parts are designated by corresponding reference numbers throughout the drawings.

### DETAILED DESCRIPTION OF THE EXEMPLARY EMBODIMENTS

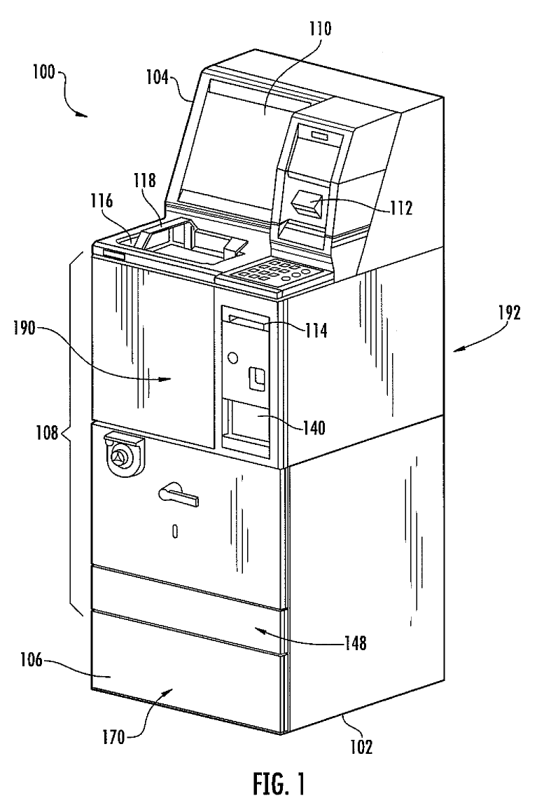

FIG. 1 illustrates a coin deposit and dispensing apparatus 100 of one embodiment of the disclosure. The apparatus 100 is for use in, for example, a retail or bank environment (e.g., retail store, bank, cash center, etc.), by customers who are, for example, persons seeking something of value for coins and commercial operators (e.g., cashier, bank teller, money handler, etc.; commercial operators being herein collectively referred to as “cashiers”). The apparatus 100 is configured to receive coins, from either a customer or cashier, and dispense a specific composition of coins to a till for use by a cashier in a retail establishment or bank establishment. The apparatus 100 simplifies and renders more effective the handling of cash in general and coins in particular and renders it possible to recirculate or recycle coins from customers, reducing costs related to cash in transit (CIT) operations and work related to handling and maintenance. Further, the apparatus 100 simplifies the daily handling of coins.

In one embodiment, the cashier will receive coins from the apparatus 100 at the beginning of the cashier's shift and will deposit coins into the apparatus at the end of the cashier's shift. The deposited coins are validated, counted, sorted, and stored in the apparatus 100. In one aspect of the disclosure, the apparatus 100 tracks the amount of cash dispensed to the particular cashier, tracks the amount of cash deposited by the same cashier, reconciles the dispensed amounts and deposited amounts, and records the difference.

Furthermore, the apparatus 100 of the present disclosure is capable for use as a cash deposit apparatus that receives cash (e.g., coins) from customers. In one embodiment, the deposited coins from customers are validated, counted, sorted, and stored in apparatus 100 in a similar manner as the coins received from the cashiers. The apparatus 100 provides as output something of value to the customer, such as, for example, a redeemable credit. For purposes hereof, “redeemable credit” refers to something of value that the user, in the role of customer, receives in the form of, for example, a voucher, store credit, credit to an account, or other form of payment to the customer in exchange for and based on the value of her deposited coins. Coins deposited by customers are recycled in the apparatus 100 in that the coins deposited by customers can be later withdrawn by a cashier for use in filling the cashier's till. Further, coins deposited by a cashier at the end of a work shift can be recycled in that the deposited coins are reused in a subsequent filling operation for the same or different cashier.

FIG. 1 illustrates the coin deposit and dispensing apparatus 100 in accordance with a first illustrated embodiment of the disclosure. The apparatus 100 is contained in a single cabinet 102 and includes several combined units or modules, each providing one or more specific functions. It is emphasized that the combination of modules, as well as functions within an individual module, described and shown herein, and in the co-assigned, incorporated-by-reference patent applications (see below), is not the only possible configuration of the apparatus. Modules and functions within individual modules can be added, altered, and excluded without departing from the disclosure. In the illustrated embodiment, the apparatus 100 generally consists of three main modules: a user interface module 104 (broadly “user interface”) at the top of the apparatus 100, a cash storage module 106 (broadly “cash storage”) at the bottom of the apparatus, and a cash processing module 108 (broadly “cash processor”) therebetween. As shown in FIG. 1, the apparatus 100 has a first (front) side 190 and a second (back) side 192.

The modules 104, 106, 108 are divided into submodules and are further described in co-assigned U.S. patent application Ser. No. 11/844,415, filed Aug. 24, 2007 (“the '415 application”), the entire contents of which is incorporated herein by reference for all purposes. Further, reference is made to the '415 application for specific details regarding the operation and function of the apparatus 100 including the details, configuration, and operation of each module 104, 106, 108. Furthermore, the apparatus 100 can operate in accordance with, or in a similar manner as, the cash recycling system disclosed in co-assigned U.S. patent application Ser. No. 11/649,953, filed Jan. 5, 2007 (the '953 application), the entire contents of which is incorporated herein by reference for all purposes.

In one embodiment, the user interface module 104 has a touch-sensitive display screen 110 (“touch screen”) through which the user may communicate with the apparatus, instructing it what to do as well as receiving useful information. The user interface module 104 also has a card reader 112, that can be used for user-identification purposes or for crediting or debiting a user's account, and a printer 114 for printing receipts, vouchers, statistics, or any other information. A controller, e.g., a CPU (not shown), is located within the cabinet 102. In one embodiment, the controller serves as a central controller unit for the entire apparatus 100, including the coin processing module 108. Other embodiments may however use one or more local controllers in some or all of the modules of the apparatus, such local controllers being configured to cooperate as required. The user interface module 104 can comprise any useful feature commonly used, such as input keys, a bar code reader, a speaker, a microphone and other I/O devices. A user, such as a cashier, will log on by inputting certain identification data. This may involve entering a personal code on the touch screen 110 and/or feeding a personal data carrier to the card reader 112 (such as a magnetic card, a smart card, an electronic ID-tag, etc.). Also, a user, such as a customer, can swipe an identifying card, such as a bank card, or enter identifying information into the user interface module 104, prior to using the apparatus.

When depositing coins, the user (e.g., customer or cashier) empties a group of unsorted coins into a coin input tray 116. The group of coins can be from a portable coin receptacle (e.g., a till—not shown) used by a cashier at a point-of-sale retail device (e.g., cash register) or a bank teller. The till stores coins received from a customer during a commercial (for example, retail or banking) transaction and provides coins for a cashier to use for change during the commercial transaction. The group of coins can include a mixed mass of coins, valid as well as invalid, as well as other foreign material such as paper clips, dust etc. Further, the group of coins can be from a customer having an amount of loose change that she wishes to deposit and/or exchange for redeemable credit or other value. The deposited group of coins could include more than one currency and/or denomination. After placing the coins in the coin input tray 116, the user (e.g., cashier or customer) may then tilt the tray by lifting it by the handle 118, thereby causing the contents to slide down the bottom surface of the tray 116 and into the interior of the cash processing module 108.

As described in the co-assigned and incorporated by reference '415 application, the cash processing module 108 sorts, validates, and counts the coins deposited in the apparatus 100. Further, the cash processing module 108 may vary from the specific apparatus and operating method disclosed in the '415 application without departing from the disclosure.

If the group of coins was deposited by a cashier from a till, the apparatus 100 records a value associated with the specific cashier and reconciles the amount deposited with an amount withdrawn by the same cashier. The use of the apparatus 100 by cashiers may include any of the uses and/or functions illustrated and described in the co-assigned and incorporated by reference applications, including the '415 application and the '953 application.

If the group of coins was deposited by a customer, the apparatus 100 determines a value related to the acceptable coins deposited and generates a printed receipt or voucher or credits an account owned by the user. The apparatus 100 can include any of the components and equipment disclosed in co-assigned U.S. patent application Ser. No. 11/558,704, filed Nov. 10, 2006 (the '704 application), and co-assigned U.S. patent application Ser. No. 11/683,140, filed Mar. 7, 2007 (the '140 application). The entire contents of both the '704 application and the '140 application are incorporated by reference herein for all purposes. Further, the use of the apparatus 100 by customers may include any of the uses and/or functions illustrated in the co-assigned and incorporated by reference applications, including the '704 application and the '140 application.

Coins deposited from cashier deposits and/or customer deposits can be recycled and dispensed by the apparatus 100 for use in the till of a cashier. At the beginning of a cashier's shift, the portable cash receptacle (e.g., till) to be used by the cashier can be filled with a specific composition of coins to be used to make change during the commercial transactions between the cashier and customers. Prior to filling a till, a cashier enters their appropriate identifying information into the apparatus. In the illustrated embodiment, the apparatus 100 includes a till drawer 148 that is accessible from the front side 190 of the apparatus. The till drawer 148 is opened to allow the user to place the till into the drawer. After closing the drawer 148, the apparatus 100 dispenses the desired specific composition of coins into the till held in the drawer 148. In one embodiment and as described in the '415 application, the cash processing module 108 includes a dispenser that selectively dispenses coins to the till or allows coins to pass to the cash storage module 106. The coins dispensed to the till can be a predetermined mix of denomination of coins that is expected to be used for making change for customers of the commercial establishment during the cashier's shift. Acceptably, according to various embodiments, the till can be a single-compartment container into which all coins are dispensed for the cashier, or a multi-compartment container with less compartments than coin denominations, or a multi-compartment container with a separate compartment for each coin denomination. The apparatus records and tracks the value of the coins dispensed to the specific cashier for later comparison with a deposited amount of coins received after the cashier's workshift is complete. After the coins have been dispensed, the drawer 148 is opened to allow the cashier to remove the till and proceed to the workstation where commercial transactions with customers occur. Additional deposits can be made by the same cashier during the cashier's shift if additional change is needed to replenish the till during the course of the cashier's workshift.

In the illustrated embodiment, the cash storage module 106 includes a transport box drawer 170 located in the cabinet 102, below the till drawer 148. As described in the '415 application, the apparatus includes access restricting components to prevent unauthorized personnel (e.g., personnel that are allowed to access the till drawer 148 but not the transport box drawer 170) from accessing the transport box drawer 170 via the till drawer 148. The access restricting components include a steel curtain 172 above the transport box drawer 170. In one embodiment, the steel curtain 172 comprises an arrangement of steel gills inclined upwardly, away from an opening direction of the till drawer 148, preventing visual and physical access to the transport box drawer 170 while allowing coins to pass into the latter. To collect coins dispensed into the transport box drawer 170, any suitable type of storage device may be arranged therein. Further, other access restricting components that differ from the steel curtain 172 may be included to restrict access to the transport box drawer 170.

Access to the transport box drawer 170 is permitted for selected personnel only. In one example, only authorized personnel (e.g., cashiers of a Cash-In-Transit (CIT) company) can access the transport box drawer. The same personnel can also instruct the system to empty the whole contents of the dispensers in the cash acceptance module 108 into the transport box drawer 170. This may be desired when the apparatus 100 is to be physically moved, reconditioned or similar.

In one embodiment, the apparatus 100 of FIG. 1 can be positioned in a retail or bank environment such that the apparatus is readily accessible by cashiers (e.g., cashiers) making deposits and withdrawals of their cash tills and customers making deposits of their personal inventories of coins. In the arrangement of FIG. 1, both customers and cashiers deposit coins into the apparatus 100 by accessing the apparatus from the front side 190. In the embodiment of FIG. 1, the cashiers access the till drawer 148 from the front side 190 of the apparatus. The apparatus 100 could be alternatively arranged to provide customer or cashier access from alternative sides of the apparatus without departing from the disclosure.

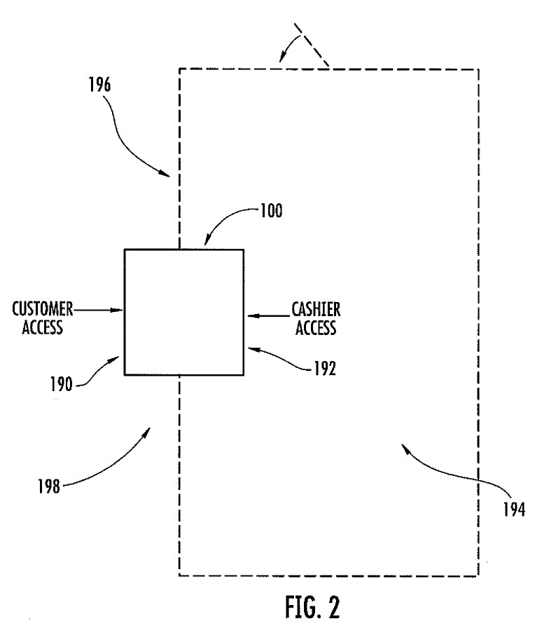

FIG. 2 illustrates an alternative embodiment of the coin deposit and dispensing apparatus 100 arranged in, for example, a retail environment 198 (analogous use in a banking environment or in another environment will be understood by one skilled in the art referring hereto). The apparatus 100 of this embodiment is generally similar to the apparatus of the first embodiment and like components are designated by like or similar reference numbers. As shown in FIG. 2, the apparatus 100 is installed in a wall 196 that defines a secure area 194 that is accessible by retail personnel, such as cashiers, cashiers, etc. In one embodiment, the front 190 of the apparatus 100 is accessible from outside the secure area 194 and the back 192 of the apparatus is accessible only from within the secure area 194. In the illustrated embodiment, customers have access to the front 190 of the apparatus for depositing coins and receiving credit for their deposit in a similar manner as describe above. As shown in FIG. 2, customer access to the secure area 194 is restricted so that only cashiers or other personnel who have access to the secure area can access the rear 192 of the apparatus 100. In this embodiment, the till drawer 148 is arranged to open to the rear 192 of the apparatus 100 so that the cashiers or other cashiers having access to the secure area 194 can fill a till in a similar manner as described above. In the embodiment of FIG. 2, the user interface module 104 can be modified to include a first input tray accessible from the front 190 of the apparatus 100 and a second input tray accessible from the rear 192 of the apparatus. Alternatively, the user interface module 104 may be similar to the embodiment of FIG. 1 in that the user interface module can have only a single input tray 116 that is accessible from the front 190 of the apparatus 100. If the apparatus 100 has a single input tray 116, cashiers would be required to make their deposits from the publicly accessible area 198. If two input trays 116 are provided, cashiers would have the option of making their deposits from either the publicly accessible area 198 or the secure area 194.

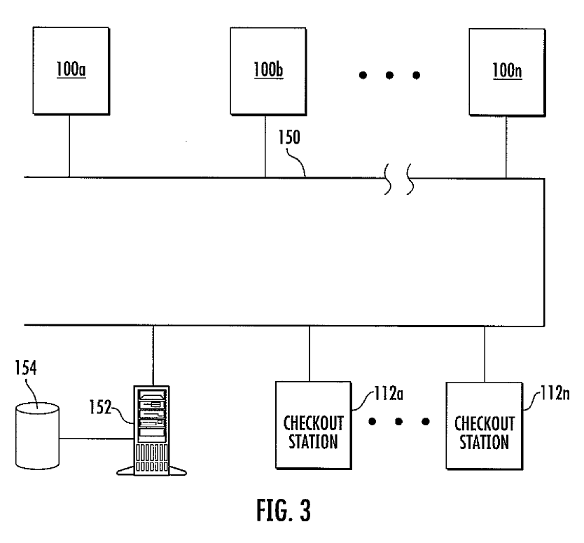

In the embodiment of FIG. 3, the apparatus 100 is connected to a computer network 150, for instance an Ethernet and TCP/IP-based local or wide area network. Furthermore, more than one apparatus 100a, 100b, . . . 100n can be connected to the network 150 to allow a user (e.g., cashier) to utilize multiple machines. For example, a cashier can deposit the contents of a till in one machine (e.g., 100a) and receive coins dispensed from a second machine (e.g., 100b) without departing from the disclosure. The cashier uses the till to make change for customers of a retail establishment at a corresponding checkout station 112a-112n or cash register. The checkout stations 112a-112n are located at the point of sale of the retail establishment. Also in one exemplary embodiment, checkout stations 112a-112n can be connected to the network 150, as well as a server 152 with an associated database 154. The server 152 may for instance support a cash/sales register application which is common to all checkout stations and to which the apparatus 100 reports all transactions performed by any of the cashiers. By connection to the computer network 150, the controller of the apparatus is capable of providing numerous accounting and management functions. For example, according to one process, the controller receives from one of the checkout stations 112a-n a first value based on the amount of commercial transactions processed at that specific checkout station during the cashier's shift. Then the controller determines a second value related to the total value of the coins from the till of the same checkout station 112a-n that has been deposited into an apparatus (e.g., 100) by the cashier at the close of her shift. The controller of the apparatus 100a provides an output representative of a correspondence or difference between the first value and the second value. The output, which, in this example, should equal the cashier's initial, dispensed till value, verifies whether the amount deposited by the cashier is the expected amount, and requests appropriate action in response. Such action may include acknowledging to the cashier that the expectations are met (i.e. giving him a “green light”), or alerting either the cashier himself or other personnel (e.g., cashier supervisor) that there is a mismatch. The server 152 may also support a cashier identifying verification application that uses prestored identification data in the database 154 to verify the identity of an individual cashier in combination with local data which are stored on a personal data carrier for each cashier and are read by readers upon initialization of a new cash transaction at the apparatus 100.

One or more cash deposit and dispensing apparatuses 100 can be used in a banking or other non-retail environment and can be connected to a network and operate in a similar or different manner as discussed above.

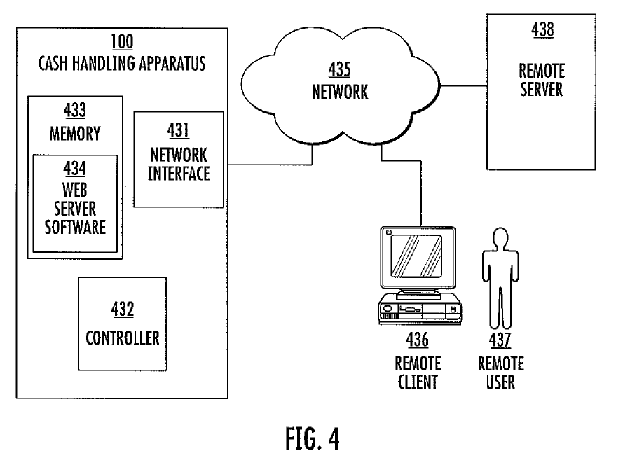

In one embodiment, one or more apparatuses 100 of the present disclosure can be connected to a network to allow remote monitoring and updating. As illustrated in FIG. 4, in one embodiment of the disclosure, the cash deposit and dispensing apparatus 100 can be connected to a network 435, such as a local area network (LAN) or a wide area network (WAN) such as the Internet, through a network interface 431. The connection may be implemented using wire based technologies, such as Ethernet, DSL, modem connection, Token Ring, etc. or wireless technologies such as Wireless LAN (WLAN), Worldwide Interoperability for Microwave Access (Wimax), GSM/GPRS, UMTS, CDMA2000, etc. Furthermore, the apparatus 100 may comprise a web server utilizing the Hypertext Transfer Protocol (HTTP). The web server can comprise web server software 434, preferably stored in the memory 433 of the cash handling apparatus 100, and executed by the controller 432 (which may be the controller of the apparatus 100). The web server provides an interface to the apparatus 100 from a remote client 436, such as a desktop computer, a laptop computer, a Personal Digital Assistant (PDA), or a mobile phone. Preferably, access to the apparatus 100 is restricted, either to certain IP addresses corresponding to the site of a company (e.g. a CIT company) being responsible for servicing the apparatus and/or a company being responsible for the cash logistics, and/or by requiring login. The login may be static or dynamic, where the remote user has to use a code generated by a code generator as is well known in the art. Alternatively or additionally, login may be restricted to browsers having a valid certificate. Virtual Private Network (VPN) technology may also be used to enhance the security of the connection.

The interface provided by the web server allows a remote user 437 to interact with the cash deposit and dispensing apparatus 100 to perform a number of tasks. For example, information may be retrieved, such as the fill level of coin storage receptacles, status of elements or components within the apparatus, hours of operation, time of last emptying, identity of specific user and values of cash deposited and/or dispensed to a specific user, number of end-users served, etc. Additionally, the operation of the apparatus may be configured or controlled using the web interface. For example, a reject frequency of the apparatus may be tuned, the amount and mixtures of coins to be dispensed to a specific user, or new software modules may be uploaded to replace software currently running on the apparatus 100. Optionally, while a remote user is servicing the apparatus, end-user access can temporarily be blocked with a message on the display indicating that the apparatus is currently being serviced to the end-user.

The network enabled cash deposit apparatus 100 may also comprise a file transfer protocol (ftp) server. This server may for example be used to upload new software to the apparatus or to retrieve log files. The web server/browser and ftp architecture can be “pull” access to the apparatus 1, where the remote user 437 initiates the communication. However, “push” access, where the apparatus initiates communication to a remote party, is equally possible with the network enabled cash deposit and dispensing apparatus 100. Messages can then be sent from the apparatus 100 to a remote user or machine using an appropriate technology, such as electronic mail (e-mail), Short Message Service (SMS) or Multimedia Message Service (MMS).

In one example, for cash logistic optimization, the apparatus 100 may send a message to a remote user, or a remote computer of the company responsible for cash collection, when fill levels of one or more cash storage receptacles exceed a threshold level, e.g. 75% of full capacity. In this way, unnecessary travel to collect cash from apparatuses where not much cash has been deposited is reduced and efficiency is improved. Another use is for the apparatus 1 to send a message to one or more recipients if the apparatus fails and becomes inaccessible to end-users. Optionally, a help button may be provided to the end-user, wherein if the help button is pressed, a message is sent to customer service personnel who can go and help the end-user. Furthermore, the apparatus may send a message to a remote user (e.g., a supervisor) when cash is dispensed or deposited from a cashier so that the flow of cash to/from the cashiers is monitored.

While the network transfer technologies of http, ftp, SMS, MMS and e-mail have been mentioned above, any suitable transfer technology is applicable and within the scope of the present disclosure. Further, remote access can be used to monitor, reset, control, etc., any feature or aspect of the apparatus 100 in addition to the features and aspects of the apparatus described herein without departing from the disclosure.

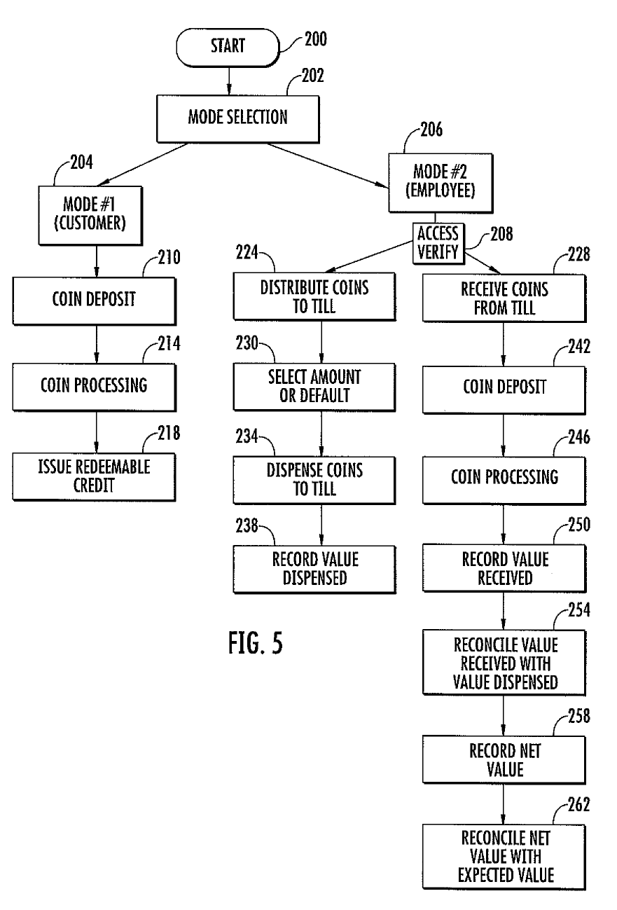

FIG. 5 illustrates a flow chart of an example operating procedure and method of the apparatus 100 of the present disclosure. At step 202, the apparatus 100 is powered on and is ready for operation. At step 200 the user (e.g., customer or cashier) accesses the user interface 104 and selects either Mode #1 (Customer Mode) shown in step 204 or Mode #2 (Cashier Mode) shown in step 206. The user interface 100 can include a touch screen or other interface for making the operating selections of the apparatus 100. According to another example method, the apparatus starts in a default Customer Mode and the cashier provides input to switch to Cashier Mode.

If the user is a customer that selects the Customer Mode at step 204, the customer proceeds to deposit coins into the apparatus as indicated at step 210. At step 214, the coin deposit and dispensing apparatus 100 operates as described herein to process the deposited coins by sorting, counting, and validating the coins deposited by the user. After the coins have been sorted counted and validated, a redeemable credit (or other value) is issued to the customer at step 218. As noted above, the redeemable credit can be in the form of a voucher, an account credit, a gift card, or other suitable form of receiving credit for the amount deposited as will be understood by those skilled in the art. Provision is made, for example, for receiving an account number, if credit to an account is desired. The coin processing step 214 includes storing the coins in the apparatus 100 until later use during a dispensing operation.

As shown in FIG. 5, at step 206, a user that is cashier selects between two operating sequences of the apparatus 100 (e.g., dispensing sequence and deposit sequence). If the cashier is starting her workshift or otherwise desires an amount of coins for her till, the cashier makes the appropriate selection for step 224 corresponding to Distribute Coins to Till (i.e., dispensing sequence). If the cashier is ending her workshift or otherwise desires to deposit the coins from her till, the cashier makes the appropriate selection for step 228 to Receive Coins From Till (i.e., deposit sequence). Appropriate security sign-in is provided in exemplary embodiments (step 208).

Upon initiation of the dispensing sequence at step 224, the cashier places the till in the apparatus and selects an amount to be dispensed or approves a default amount at step 230. The selected amount (or default amount) of coins is dispensed to the till at step 234. The controller of the apparatus 100 records the value of the dispensed coins and the identifying information about the cashier at step 238. Typically, the cashier will remove the till and proceed to the checkout station or cash register and proceed to make commercial transactions with customers. During the commercial transactions, cash received from the customers is received in the till and change due to customers is removed from the till by the cashier. Alternative, the till could be used at a self-service checkout station that allows the user to deposit cash and automatically receive change.

Upon initiation of the deposit sequence at step 228, the cashier deposits coins at step 242 into the apparatus 100. Typically, the deposited coins correspond with the remaining coins in the cashiers till at the end of a workshift. At step 246, the deposited coins are processed in a manner as described herein by sorting, counting, and validating the coins deposited by the cashier. At step 250, the value of the deposited coins is recorded. Steps 254, 258, 262 represent one of the many processes of which the apparatus is capable. At step 254 the value of the coins received from a specific cashier is reconciled and compared with the recorded value of coins dispensed to the same cashier (e.g., the amount recorded at step 238 in a prior dispensing operating sequence by the same cashier). At step 258 the net value obtained by the comparison of the value received with the value dispensed for a specific cashier is recorded. At step 262, the net value is compared and reconciled with an expected value, such as the value of commercial transactions recorded by the cash checkout station based on the amount of commercial transactions processed at that specific checkout station during the cashier's shift. After the comparison of the net value with the expected value, appropriate action can be taken such as acknowledging that the net value equals the expected value or the net value is less than the expected value.

The operating procedure and method discussed herein can deviate from what is shown and/or described without departing from the scope of the disclosure. Alternative or additional steps can be provided, steps can be eliminate, and/or the order or sequence of operation can be modified without departing from the disclosure.

The network arrangements and specific features of FIGS. 3 and 4 are illustrative of exemplary embodiments of the disclosure and could be modified and/or combined without departing from the disclosure. Further, the apparatus 100 of the present disclosure could include other modifications. For example the apparatus 100 could be configured such that the till drawer 148 is raised to a higher position so that the till drawer is more easily accessible by a cashier. Also, the transport box drawer 170 may be accessible from other than the front side 190 of the apparatus without departing from the disclosure.

In one embodiment, the apparatus 100 is used within a shopping mall, or the environment, where the apparatus is accessible to cashiers or cashiers of more than one store. The cashiers or cashiers of each of the stores can use the same cash deposit and dispensing apparatus 100 for receiving and dispensing coins for use in providing change for retail transactions in each store. The controller of the apparatus 100 would track the use of the apparatus by cashiers of the stores and account for the amount of coins deposited and withdrawn by each store. Other applications and environments for use of the apparatus 100 include: retail, shopping malls, departments stores, retail superstores, banks, transportation industry, ticket vending, casinos, gaming, restaurants, airports, stewards, gas stations, churches, or any other application and environment where the deposit and dispensing of coins is needed. In any of the various applications, the apparatus 100 may be used by public persons, customers, cashiers, bank tellers, till owners, CIT providers and cashiers, or any other personnel involved with the handling of cash that fill and reconsolidate the apparatus.

The apparatus 100 may include a note processing module (not shown) for receiving and/or dispensing notes. Notes may be deposited into the apparatus 100 from cashiers and/or customers without departing from the disclosure. The notes received into the apparatus may be recycled and reused in a similar manner as described herein or the notes could be stored in the apparatus 100 for later removal by a cashier or other personnel. A suitable note processing module is shown and described in the above-referenced '140 application that has been incorporated by reference herein.

The foregoing description of the disclosure illustrates and describes various embodiments of the present disclosure. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments that are within the scope of the claims. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure without departing from the scope of the disclosure.

What is claimed is:

1. A method of recycling coins comprising:
providing a coin deposit and dispensing apparatus, the coin deposit and dispensing apparatus comprising a user interface, which is accessible both to customers and to cashiers, and a cash processor for sorting, counting, validating, and dispensing coins;
operating the coin deposit and dispensing apparatus in a first mode, the operating in the first mode comprising receiving a first amount of coins from a customer accessing the user interface of the coin deposit and dispensing apparatus, sorting, counting, and validating, via the cash processor, the first amount of coins, and issuing the customer a redeemable credit;
operating the coin deposit and dispensing apparatus in a second mode, the operating in the second mode comprising either (i) receiving, validating, counting and sorting a second amount of coins received from a cashier accessing the user interface of the coin deposit and dispensing apparatus, determining a value of the second amount of coins, and reconciling the value of the second amount of coins with an expected value or (ii) dispensing a third amount of coins from the cash processor to a cashier

2. The method of claim 1 wherein the dispensing the third amount of coins comprises dispensing a specific amount of coins into a till to be used by a cashier to make change in commercial transactions.

3. The method of claim 2 wherein the dispensing the third amount of coins provides the cashier with an initial amount of coins in the till.

4. The method of claim 1 wherein the depositing the second amount of coins comprises emptying a till by a cashier at the end of the cashier's work shift, the second amount of coins comprising coins received from a customer during a commercial transaction.

5. The method of claim 1 wherein depositing the first amount of coins comprises depositing an amount of loose change and determining a value of the first amount of coins, and the issuing the customer a redeemable credit comprises generating at least one of a printed voucher, and an account credit corresponding to the value of the first amount of coins.

6. The method of claim 1 wherein the operating the coin deposit and dispensing apparatus in the second mode comprises the cashier first dispensing the third amount of coins from the cash processor to the cashier's till at the beginning of the cashier's work shift, and thereafter, the cashier depositing the second amount of coins from the cashier's till at the end of the cashier's work shift.

7. The method of claim 6 further comprising recording a first value comprising a total value of the third amount of coins, recording a second value comprising a total value of the second amount of coins, and reconciling the first value and the second value to record a net value associated with the cashier.

8. The method of claim 7 further comprising comparing the net value associated with the cashier with an expected amount and providing indication of the comparison.

9. The method of claim 1 wherein the coin deposit and dispensing apparatus further comprises a cash storage unit, and the coin deposit and dispensing apparatus is contained in a single cabinet housing the user interface, the cash processor, and the cash storage module.

10. The method of claim 1 wherein the cash processor comprises a till drawer, the operating the coin deposit and dispensing apparatus in the second mode comprises placing a till in the till drawer, wherein the dispensing the third amount of coins comprises discharging the third amount of coins into the till.

11. The method of claim 10 wherein the operating the coin deposit and dispensing apparatus in the second mode further comprises removing the till from the till drawer.

12. The method of claim 1 wherein the coin deposit and dispensing apparatus is positioned in at least one of a retail environment and a bank environment and the user interface is accessible to cashiers and customers.

13. The method of claim 12 wherein the coin deposit and dispensing apparatus has a front side, and the user interface is accessible by cashiers and customer from the front side of the coin deposit and dispensing apparatus.

14. The method of claim 12 wherein the coin deposit and dispensing apparatus has a front side and a back side and is positioned in a wall, the wall separates a retail environment accessible by customers and a secure area accessible by cashiers and inaccessible by customers, the user interface is accessible by cashiers and customers from the front side of the apparatus, and the user interface is accessible by cashiers from the back side of the apparatus and is inaccessible by customers from the back side of the apparatus.

15. The method of claim 14 wherein the user interface comprises a first input tray accessible from the front of the apparatus, and a second input tray accessible from the rear of the apparatus, and the depositing the first amount of coins comprises placing coins in the first input tray and the depositing the second amount of coins comprises placing coins in the second input tray.
